(19) United States
(12) Patent Application Publication
(10) Pub. No.: US 2025/0094787 A1
(43) Pub. Date: Mar. 20, 2025

(54) PRIVACY-PROTECTIVE KNOWLEDGE SHARING USING A HIERARCHICAL VECTOR STORE

(71) Applicant: Oracle International Corporation, Redwood Shores, CA (US)

(72) Inventors: Karoon Rashedi Nia, Vancouver (CA); Anatoly Yakovlev, Hayward, CA (US); Sandeep R. Agrawal, San Jose, CA (US); Ridha Chahed, Redwood City, CA (US); Sanjay Jinturkar, Basking Ridge, NJ (US); Nipun Agarwal, Saratoga, CA (US)

(21) Appl. No.: 18/808,300

(22) Filed: Aug. 19, 2024

Related U.S. Application Data
(60) Provisional application No. 63/583,147, filed on Sep. 15, 2023.

(51) Int. Cl. G06N 3/0475; G06F 21/62; G06N 3/092

(52) U.S. Cl. CPC G06N 3/0475; G06F 21/6218; G06N 3/092

(57) ABSTRACT

Disclosed herein are various approaches for sharing knowledge within and between organizations while protecting sensitive data. A machine learning model may be trained using training prompts querying a vector store to prevent unauthorized user disclosure of data derived from the vector store. A prompt may be received and a response to the prompt may be generated using the machine learning model based at least in part on the vector store.

### RELATED APPLICATION DATA AND CLAIM OF PRIORITY

This application claims the benefit of U.S. Provisional Application No. 63/583,147 entitled “Inter- And Intra-Organizational Knowledge Sharing Using HeatWave AutoML And Hierarchical Vector Store”, filed Sep. 15, 2023, the contents of which are incorporated by reference for all purposes as if fully set forth herein.

### TECHNICAL FIELD

The present disclosure relates to sharing knowledge within and across organizations while protecting proprietary data.

### BACKGROUND

Organizations often need to analyze a large number of digital artifacts and produce aggregated reports based on those analyses. In some situations, however, such analyses require access to data not in the possession of the party conducting these analyses. This data could be in the possession of parties within a different sub-division of the same organization as the analyzing party, or the data could be in the possession of parties within a different organization than the analyzing party. The knowledge derived from such analyses might even be valuable to the party or parties who do possess that data. Yet some parties may not be willing to share their sensitive data irrespective of the potential rewards.

For example, a traffic safety organization might want to create reports on traffic accidents for a given year. Creating these reports would involve accessing accident data possessed by automobile insurance companies. While the automobile insurance companies might find these reports useful, they might be unwilling to share the accident data because of industry regulations.

As another example, a hiring manager in a company might want to access salary information for a particular position so that the hiring manager knows what salary figures to offer prospective hires. The hiring manager would therefore attempt to obtain the salary information for the particular position from the company's human resources department. The human resources department, however, might be unwilling to share the salary information to protect the privacy of employees in the particular position.

Thus, it would be desirable to develop a way to share knowledge within and among organizations while protecting private, proprietary, and sensitive data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

### In the Drawings:

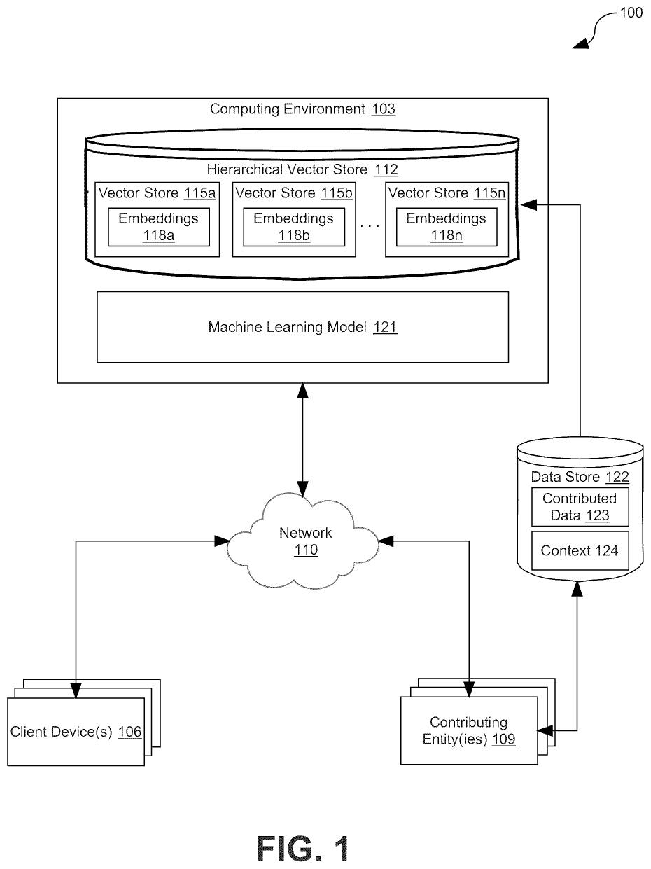

FIG. 1 illustrates a block diagram depicting an example of a network environment 100, in an embodiment.

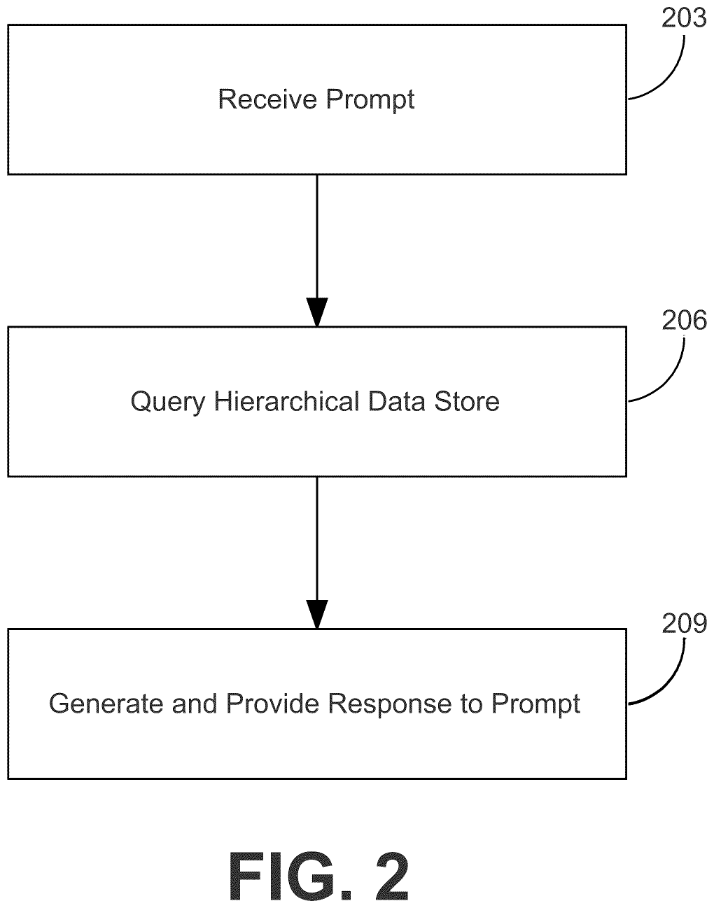

FIG. 2 is a flow diagram that depicts an example of the operation of a portion of a machine learning model, in an embodiment.

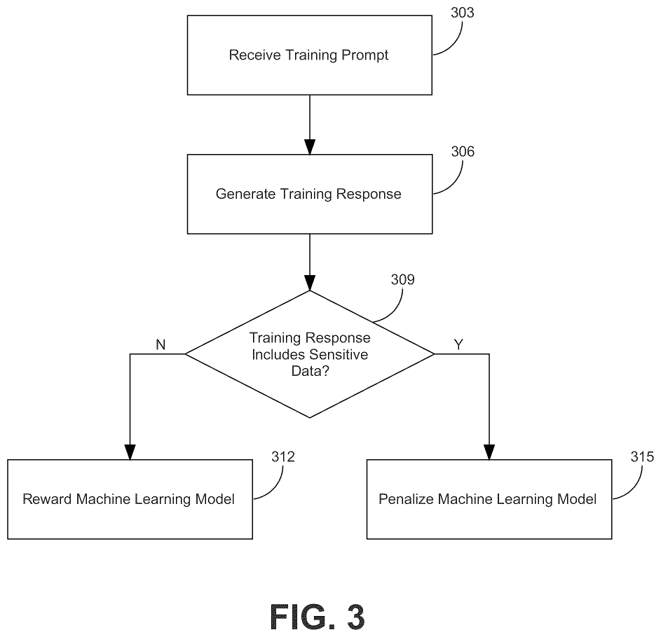

FIG. 3 is a flow diagram that depicts an example of the operation of a portion of a machine learning model, in an embodiment.

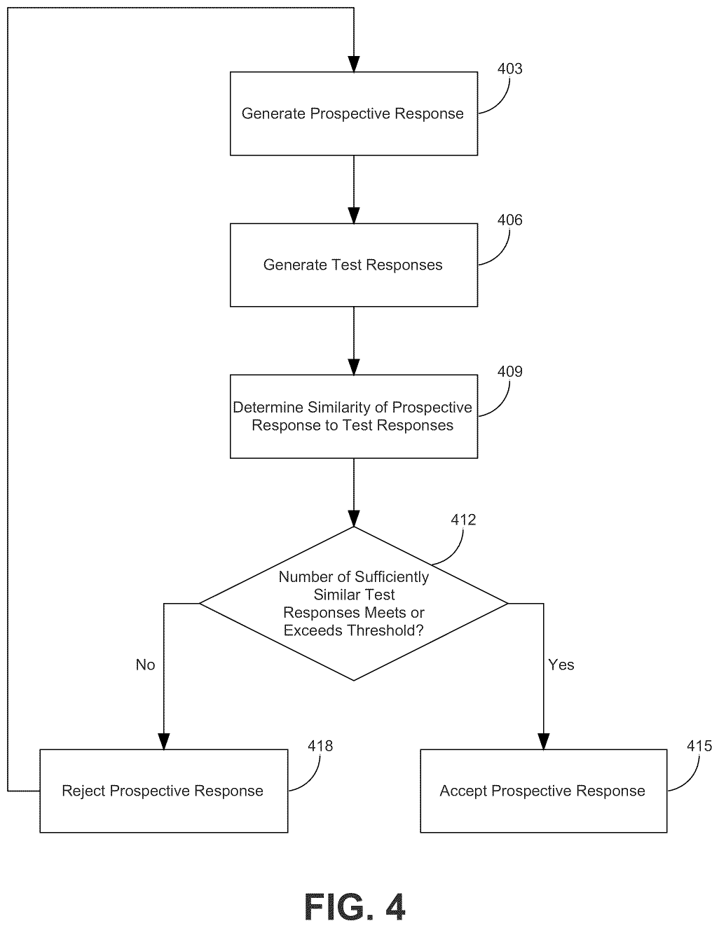

FIG. 4 is a flow diagram that depicts an example of the operation of a portion of a machine learning model, in an embodiment.

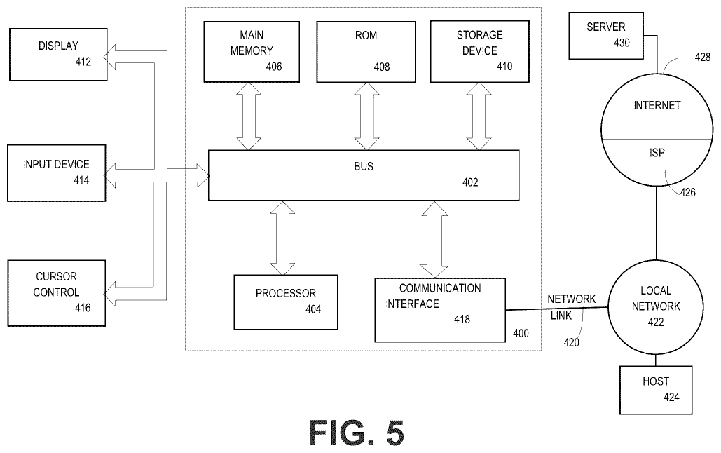

FIG. 5 is a block diagram that illustrates a computer system upon which an embodiment of the invention may be implemented.

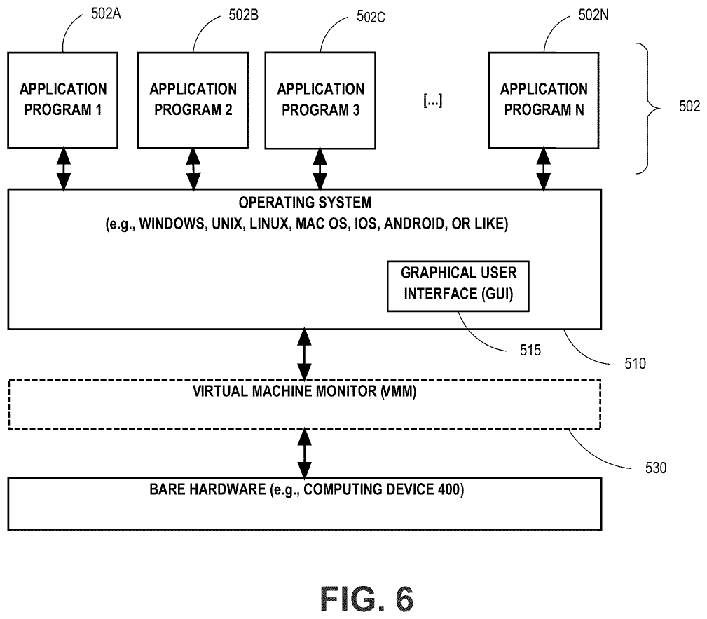

FIG. 6 is a block diagram of a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Disclosed herein are various approaches for sharing knowledge within and between organizations while protecting sensitive data. The disclosed approaches enable entities to exchange knowledge derived from data without exchanging the data itself. To facilitate privacy-protective knowledge sharing, multiple entities may contribute data to a shared hierarchical vector store, at least a portion of which could be sensitive data. The data may be represented in the hierarchical vector store by embeddings.

The hierarchical vector store may be protected by fine-grained access control rules. The hierarchical vector store may include multiple individual vector stores, each of which is associated with a different entity. Each vector store may have different access control rules for accessing the embeddings therein. A user may access data in a particular vector store if the user's access privileges meet the access control rules for that vector store.

A machine learning model may enable users to query the hierarchical vector store to extract contextual knowledge while ensuring data privacy and preventing information leakage. The machine learning model may receive a prompt from a user and access embeddings from the hierarchical vector store to generate a response to the prompt. The machine learning model may be fine-tuned to avoid including sensitive data in responses that the machine learning model generates. And even if the machine learning model generates a response that does include sensitive data, the machine learning model may employ masking techniques to ensure that such responses are rejected. Responses that do not include sensitive data, however, may be accepted and provided to the prompting user.

### System Overview

FIG. 1 illustrates a block diagram depicting an example of a network environment 100, in an embodiment. The network environment 100 may include a computing environment 103, one or more client devices 106, one or more contributing entities 109, and potentially other components in communication via a network 110.

The network 110 includes the Internet, intranets, extranets, wide area networks (WANs), local area networks (LANs), wired networks, wireless networks, other suitable networks, or any combination of two or more such networks. The networks may include satellite networks, cable networks, Ethernet networks, and other types of networks.

The computing environment 103 may include a computing device, such as a server computer, that provides computing capabilities. Alternatively, the computing environment 103 may employ multiple computing devices that are arranged in one or more server banks or computer banks. In one example, the computing devices may be located in a single installation. In another example, the computing devices for the computing environment 103 may be distributed among multiple different geographical locations. In one case, the computing environment 103 may include multiple computing devices that together may form a hosted computing resource or a grid computing resource. In addition, the computing environment 103 may operate as an elastic computing resource where the allotted capacity of computing-related resources, such as processing resources, network resources, and storage resources, may vary over time. In other examples, the computing environment 103 may include or be operated as one or more virtualized computer instances that may be executed to perform the functionality that is described herein.

Various data may be stored in a hierarchical vector store 112 that is accessible to the computing environment 103. The hierarchical vector store 112 may be representative of a plurality of data stores. The data stored in the hierarchical vector store 112 may be associated with the operation of the various applications or functional entities described below. The hierarchical vector store 112 may include one or more vector stores 115 and potentially other data. Each of the vector stores 115 may store one or more embeddings 118 and potentially other data.

Various applications or other functional entities may be executed in the computing environment 103. Components executed in the computing environment 103 may include a machine learning model 121 and potentially other applications, services, processes, systems, engines, or functionality not discussed in detail herein.

In addition, various data may be stored in a data store 122 that may be accessible to the computing environment 103 and/or the contributing entity 109, in some cases via the network 110. The data store 122 may be a component of the computing environment 103, the contributing entity 109, both, or neither. Data stored in the data store 122 may be directly accessed and/or modified by the contributing entity 109 to whom that data belongs. The data store 122 may be representative of a plurality of data stores. The data stored in the hierarchical vector store 112 may be associated with the operation of the various applications or functional entities described below. Data stored in the data store 122 may include contributed data 123 and potentially other data. In some implementations, the data stored in the data store 122 may be accessed by the machine learning model 121 directly or using a pointer from an embedding 118.

The client device(s) 106 may represent multiple client devices 106 coupled to the network 112. The client device 106 may include a processor-based system, such as a computer system, that may include a desktop computer, a laptop computer, a personal digital assistant, a cellular telephone, a smartphone, a set-top box, a music player, a tablet computer system, a game console, an electronic book reader, or any other device with like capability. The client device 106 may also be equipped with networking capability or networking interfaces, including a localized networking or communication capability, such as a near-field communication (NFC) capability, radio-frequency identification (RFID) read or write capability, or other localized communication capability.

In addition, the client device 106 may be configured to execute various applications. Applications executed by the client device 106 may access network content served up by the computing environment 103 or other servers, thereby rendering a user interface on a display, such as a liquid crystal display (LCD), touch-screen display, or other type of display device.

The contributing entity (ies) 109 may represent one or more entities that contribute data to the hierarchical data store 115 (and/or represent one or more computing device(s) operated by the one or more entities). The contributing entities 109 may be associated with multiple different organizations and/or different subgroups within a single organization.

### Hierarchical Vector Store

The hierarchical vector store 112 may store data belonging to contributing entities 109 in various vector stores 115a-n (collectively, “vector stores 115”). The vector stores 115 may be any data store capable of storing vectors representing data points in a multi-dimensional space. Each of the vector stores 115 may be associated with a single one of the contributing entities 109. The vector stores 115 of the hierarchical vector store 112 may include embeddings 118a-n (collectively, “embeddings 118”) corresponding to contributed data 123 provided by contributing entities 109 for storage in the hierarchical vector store 112.

A vector store 115 may have one or more fine-grained access control rules that control the accessibility of the contributed data 123 by users. A vector store's 115 access control rules may be defined by, for example, the contributing entity 109 associated with the vector store 115. A vector store's 115 access control rules define what information from the contributed data 123 may and may not be revealed to a user in a response to a prompt submitted by that user.

The embeddings 118 may comprise vector representations that map objects to points in a vector space. The embeddings 118 may comprise encoded representations of contributed data 123. Vector store 115 indexes embeddings 118 to items of contributed 123. In general, such indexes index embeddings or vector according to similarity. One approach for indexing embeddings and retrieving similar content using the index is HNSW (Hierarchical Navigable Small World). An example of vector store is described in U.S. patent application No. 63/583,298, filed by Shasank Kisan Chavan, et. al. on Sep. 17, 2024 and U.S. patent application No. 63/563,926, filed by Tirthankar Lahiri, et. al. on Mar. 11, 2024; the content of each these applications are incorporated herein by reference.

The contributed data 123 may comprise encoded and/or raw data such as, for example, text files, audio files, video files, and various other types of data. Access to contributed data 123 corresponding to the embeddings 118 within a particular vector store 115 may be managed by fine-grained access control rules defined for that vector store 115. An embedding 118 may be used as a key to access contributed data. The embedding 118 may therefore enable, for instance, the machine learning model 121 to access the corresponding contributed data 123.

A contributing entity 109 may provide raw or encoded data as contributed data 123 to be accessible via the hierarchical vector store 112. A contributing entity 109 may be associated with a particular vector store 115 in the hierarchy vector store 112. A contributing entity's 109 vector store 115 may comprise one or more embeddings 118 that represent contributed data 123 belonging to that contributing entity 109 and/or a pointer to that contributed data 123.

### Machine Learning Model

The machine learning model 121 may generate responses to prompts from users using context 124 retrieved from the hierarchical vector store 112. The machine learning model 121 may be, as one example, a large language model (LLM). The machine learning model 121 may use machine learning techniques like, for instance, natural language processing and image processing to derive contextual knowledge from the contributed data 123 that may be used to generate responses.

A user may create a prompt using the client device 106. The client device 106 may provide the prompt to the machine learning model 121 and receive a response from the machine learning model 121 in return. The client device 106 may enable the user to view the response. A user of the client device 106 may be associated with one or more of the contributing entities 109.

### Generating Responses to Prompts

The machine learning model 121 may access the hierarchical vector store 112 to generate responses to prompts received from users. The machine learning model 121 may be, for example, a large language model. A response to a prompt issued by a user is generated by the machine learning model 121 using context 124 retrieved from hierarchical vector store 112. The retrieval is based on the prompt and is subject to any relevant access control rules that should be applied to the user.

When the machine learning model 121 accesses an embedding 118 within the hierarchical vector store 112 to obtain information for generating a response to a prompt, the machine learning model 121 uses an encoding of the prompt to request hierarchical vector store 112 to return associated context 124 that is similar to the prompt. The machine learning model 121 then uses the context 124 in combination with the encoded prompt to generate the response. For the sake of simplicity, however, a phrase such as “the machine learning model 121 obtains certain information from an embedding 118” or similar phrase may be used herein to mean uses an encoding of the prompt to request hierarchical vector store 112 to return associated context 124 that is similar to the prompt.

The response may exclude sensitive data, such as data that a user providing the prompt is not authorized to access. Terminology such as “sensitive data” may be used herein to mean data that a user is not authorized to access under one or more access control rules. For example, some data may be sensitive data with respect to a particular user if that data is attributable to an individual entity and the user is not authorized to access data attributable to that individual entity.

To give an example, suppose an organization includes multiple different departments, including an engineering department and a human resources (HR) department. When hiring a new employee, a manager from the engineering department might want to know the average salary of employees in similar positions, thereby enabling the manager to offer a competitive salary. To obtain this information, the engineer may query the machine learning model 121 using a prompt such as, “What is the average salary for an entry-level engineer within our organization?” The machine learning model 121 may then access embeddings 118 representing salary data from a vector store 115 associated with the HR department to obtain this information and generate a response accordingly. In this case, the engineering manager has access to average salary data but not individualized salary data. The response would therefore only include the average salary of all entry-level engineers in the organization, which the manager is authorized to access. The machine learning model 121 would not, however, include information on the salary of any individual entry-level engineer, which the manager is not authorized to access. Likewise, if the manager queried the machine learning model 121 using a prompt like, “What is the salary for Kyle Katarn in the engineering department?”, the machine learning model 121 would not provide this information since the manager is not authorized to access it according to an access control rule.

To give another example, suppose a third-party organization wants to study road safety using data belonging to several insurance companies. Certain regulations may prohibit the insurance companies from sharing sensitive data with the third-party organization. This prohibition may be reflected in one or more access control rules defined for vector stores 115 associated with the insurance companies. Thus, if a user associated with the third-party organization created a prompt asking for “a list of traffic accidents that occurred in Athens, Georgia in 2021,” such a list may contain sensitive data. That is, information from that list may be attributable to an individual insurance company and/or an individual customer of an insurance companies. The machine learning model 121 may therefore provide a response that excludes such sensitive data, or else deny access to this information altogether. If the user associated with the third-party organization creates a prompt such as, “What is the total number of traffic accidents that occurred in Athens, Georgia in 2021?”, then the machine learning model 121 can provide this figure in its response since the figure does not include sensitive data.

### Example Approaches to Preventing Leakage of Sensitive Data

Various approaches may be employed to help prevent leakage of sensitive data in responses generated by the machine learning model 121. For example, the machine learning model 121 may be trained to exclude sensitive data a user is not authorized to access when generating a response to a prompt from that user. For example, the machine learning model 121 may be trained to generate responses that aggregate information from multiple different vector stores 115 while refraining from revealing sensitive data. As another example, a second machine learning model may be used to validate responses generated by the machine learning model 121. As an additional example, responses generated by the machine learning model 121 may be masked to further prevent the leakage of sensitive data.

### Training to Prevent Sensitive Data Leakage

In some implementations, the machine learning model 121 may be fine-tuned during training to avoid revealing sensitive data. Training and fine-tuning may include various approaches such as reinforcement learning from human feedback or other approaches to reinforcement learning. For example, when the machine learning model 121 generates a training response including sensitive data in response to a training prompt, the machine learning model 121 may be penalized. As another example, when the machine learning model 121 generates a response that includes aggregated data (or otherwise excludes sensitive data), the machine learning model 121 may be rewarded. Terminology such as “aggregated data” may be used herein to mean data that is derived from information obtained via one or more embeddings 118 from the hierarchical vector store 112 but excludes or does not reveal sensitive data included in that information. In some implementations, one or both of the approaches for validating responses and masking responses discussed below may be incorporated into training the machine learning model 121.

### Validating Responses to Prevent Sensitive Data Leakage

In some implementations, responses generated by the machine learning model 121 may be validated by a second machine learning model, the validation model (not shown). The validation model may be, for example, a zero-shot classification model. When the machine learning model 121 generates a response, the validation model may be asked one or more questions to verify that the response does not include sensitive data. For example, the validation model may be asked, “Does the response contain personal information, address, phone number, or any other personal identifiable information?” or “Does the response contain social security number (PII)?”

### Masking to Prevent Sensitive Data Leakage

In some implementations, the machine learning model 121 may employ a masking approach to avoid revealing sensitive data in responses that it generates. Any suitable data masking technique may be used to sanitize responses of sensitive data.

As one example, a hypothesis test may help ensure that sensitive data leakage is prevented. That is, a hypothesis may be used to accept or reject responses generated by the machine learning model 121. After the machine learning model 121 generates a response to a prompt as discussed above—the “prospective” response—the machine learning model 121 may also generate a plurality of test responses to the prompt. Each test response may be generated using only one of the vector stores 115 such that one test response is generated for each vector store 115. The prospective response may be compared to the test responses. The prospective response may then be accepted or rejected based on how many of the test responses are sufficiently similar to the prospective response. A test response is sufficiently similar if the test response's similarity score with respect to the prospective response meets or exceeds a predefined threshold.

If the number of the individual responses that are sufficiently similar to the response generated using all the vector stores 115 is below a pre-defined threshold (but is greater than zero), the response is rejected. This means that only a few vector stores are contributing to the response and may be leaking some sensitive data. If a response is rejected, it means that the machine learning model 121 may be leaking some private data and is required to regenerate the output. If the number of sufficiently similar test responses meets or exceeds the pre-defined threshold—or if no test responses are sufficiently similar to the prospective responses—then the response is accepted. The response is accepted because the number of vector stores 115 that contributed to the prospective response makes it unlikely that any one of them leaked sensitive data.

As an example, suppose the machine learning model 121 generates a response X₀ to a prompt using information obtained via the hierarchical vector store 112. The machine learning model 121 may also generate n test responses Xₙ, where n is the total number of vector stores 115. Each of the test responses Xₙ may be generated using one particular vector store 115 to the exclusion of the other vector stores 115. Thus, each of the test responses Xₙ is generated using a different vector store 115 than the other test responses Xₙ.

The machine learning model 121 may determine a degree of similarity of the response X₀ to each of the test responses Xₙ. The machine learning model 121 may make this determination based on cosine similarity, dot product, Euclidean distance, word embeddings, or any other suitable technique depending on the application. The machine learning model 121 may then determine a number of the test responses Xₙ that have a degree of similarity to the response X₀ that meets or exceeds a predefined similarity threshold. This predefined similarity threshold may be a tunable parameter.

If the number of sufficiently similar test responses Xₙ meets or exceeds a predefined threshold number (which may itself be a tunable parameter), then the machine learning model 121 may accept the response X₀. In that case, the machine learning model 121 likely generated the response X₀ using information from a large enough portion of the vector stores 115 that no information in the response X₀ is attributable to a particular vector store 115. In addition, if none of the test responses Xₙ are sufficiently similar to the response X₀, the response X₀ may also be accepted. If the number of sufficiently similar test responses does not meet or exceed this predefined threshold number, then the machine learning model 121 may reject the response X₀. If the response X₀ is rejected, then the response X₀ likely includes sensitive data because it may be attributable to a particular vector store 115. The machine learning model 121 may then regenerate a response to the same prompt.

To illustrate, suppose a user provides a prompt that asks, “What is the average growth in energy consumption in the widget industry?” If the machine learning model's 121 response gives a figure that has a high degree of similarity to the growth in energy consumption for Widgets-R-Us, the response may be rejected. The machine learning model 121 may then regenerate a response. If the machine learning model's 121 response gives a figure that is similar to the energy consumption for every company in the widget industry (or at least those who are contributing entities 109), then the response may be accepted and provided to the user. The response may also be accepted if the given figure is not sufficiently similar to any of the companies in the widget industry who are contributing entities 109.

### Example Process for Generating a Response to Prompt

FIG. 2 is a flow diagram that depicts an example of the operation of a portion of the machine learning model 121, in an embodiment. The flow diagram of FIG. 2 provides merely an example of the many different types of functional arrangements that may be employed to implement the operation of the depicted portion of the machine learning model 121. As an alternative, the flow diagram of FIG. 2 may be viewed as depicting an example of elements of a method implemented within the networked environment 100.

At step 203, the machine learning model 121 receives a prompt. The response may be a question, request, or other statement intended to cause the machine learning model 121 to provide a response that includes information relevant to the prompt. The prompt may be, for example, a natural language prompt.

At step 206, the machine learning model 121 queries the hierarchical data store 112 for information related to the prompt. As one example, the machine learning model 121 may encode the prompt into a query vector in a same vector space as the embeddings 118 stored in the hierarchical vector store 112. The machine learning model 121 may then apply a similarity measure to compare the query vector with the embeddings 118 in the various vector stores 115. The machine learning model 121 may identify embeddings 118 that are most similar to the query vector, based on a predetermined threshold of similarity. The machine learning model 121 may then access data from contributed data 123 to retrieve context 124 that is associated with the identified embeddings 118, which may be related to the prompt.

At step 209, the machine learning model 121 generates a response to the prompt and provides the response to the client device 106. The response may be generated using the data from the context 124. The machine learning model 121 may generate the response using various machine learning approaches, including, for example, the approaches described in U.S. Pat. App. No.______, filed______, which is incorporated by reference herein in its entirety. In some implementations, the machine learning model 121 may be trained to avoid including sensitive data in the response. For instance, the machine-learning model may be fine-tuned to exclude sensitive data using various reinforcement learning approaches such as reinforcement learning from human feedback. In some implementations, the machine learning model 121 may perform data masking on the response to determine whether the response includes sensitive data. If it does, the machine learning model 121 may regenerate the response until the machine learning model 121 determines that the response does not include sensitive data. Once a final response is generated, the response may be provided to the user of the client device 106.

### Example Process for Training to Prevent Sensitive Data Leakage

FIG. 3 is a flow diagram that depicts an example of the operation of a portion of the machine learning model 121, in an embodiment. The flow diagram of FIG. 3 provides merely an example of the many different types of functional arrangements that may be employed to implement the operation of the depicted portion of the machine learning model 121. As an alternative, the flow diagram of FIG. 3 may be viewed as depicting an example of elements of a method implemented within the networked environment 100.

At step 303, the machine learning model 121 receives a training prompt. The training prompt may be, for example, any natural language query requesting information that may be obtained from the hierarchical vector store 115.

At step 306, the machine learning model 121 generates a training response to the training prompt. The machine learning model 121 may generate the training response to the training prompt using, for instance, the process described in FIG. 2. Thus, the machine learning model 121 query the hierarchical vector store 115 to obtain information used to generate the training response.

At step 309, the machine learning model 121 determines whether the training response includes sensitive data. The machine learning model 121 may make this determination based on, for example, the process described below in FIG. 4. As another example, the machine learning model 121 may make this determination based on feedback from a human user regarding whether the training response includes sensitive data. If the training response does not include sensitive data, the process proceeds to step 312. Otherwise, the process proceeds to step 315.

At step 312, the machine learning model 121 is rewarded for generating a training response that does not include sensitive data. The machine learning model 121 may, for instance, update a reward model to reflect positive reinforcement of the training response, therefore making it more likely that the machine learning model 121 produces similar results in the future—and therefore more likely to generate responses that do not include sensitive data.

At step 315, the machine learning model 121 is penalized for generating a training response that includes sensitive data. The machine learning model 121 may, for instance, update a reward model to reflect negative reinforcement of the training response, therefore making it less likely that the machine learning model 121 produces similar results in the future—and therefore less likely to generate responses that do include sensitive data.

### Exemplary Process for Masking to Prevent Sensitive Data Leakage

FIG. 4 is a flow diagram that depicts an example of the operation of a portion of the machine learning model 121, in an embodiment. The flow diagram of FIG. 4 provides merely an example of the many different types of functional arrangements that may be employed to implement the operation of the depicted portion of the machine learning model 121. As an alternative, the flow diagram of FIG. 4 may be viewed as depicting an example of elements of a method implemented within the networked environment 100.

At step 403, the machine learning model 121 generates a prospective response to a prompt. The machine learning model 121 may generate the prospective response using, for example, the process described in FIG. 2.

At step 406, the machine learning model 121 generates a plurality of test responses to the prompt. The machine learning model 121 may generate one test response for each individual vector store 115 in the hierarchical vector store 112; each of these test responses may be generated using only one of the vector stores 115. Thus, each test response may correspond to the contributed data 123 data of a single contributing entity 109.

At step 409, the machine learning model 121 determines how similar each of the test responses is to the prospective response. The machine learning model 121 may make this determination based on cosine similarity, word embeddings, or any other suitable technique.

At step 412, the machine learning model 121 determines whether the number of test responses that are sufficiently similar to the prospective response meets or exceeds a predefined threshold number. The similarity of each test response may be determined using a similarity score. The degree of similarity that constitutes sufficient similarity may be a tunable parameter, such as a predefined threshold similarity score. Likewise, the predefined threshold number of sufficiently similar responses may also be a tunable parameter. If the number of sufficiently similar test responses does meet or exceed the predefined threshold, the process proceeds to step 415. Otherwise, the process proceeds to step 418.

At step 415, the machine learning model 121 accepts the prospective response. Because the number of sufficiently similar test responses meets or exceeds the predefined threshold number, it is likely that the prospective response does not include sensitive data. That is, the number of vector stores 115 that the machine learning model 121 used to generate the prospective response is large enough that it is unlikely the prospective response includes sensitive data attributable a particular vector store 115, and therefore a particular contributing entity 109. Thus, the prospective response may be used as a response to the user prompt. The machine learning model 121 may then provide the accepted response to the client device 106 to be viewed by the user.

At step 418, the machine learning model 121 rejects the prospective response. Because the number of sufficiently similar test responses did not meet or exceed the predefined threshold number, it is likely that the prospective response does not include sensitive data. Thus, the prospective response may be used as a response to the user prompt. That is, the number of vector stores 115 that the machine learning model 121 used to generate the prospective response is small enough that it is likely the prospective response includes sensitive data attributable a particular vector store 115, and therefore a particular contributing entity 109. Thus, the prospective response may not be used as a response to the user prompt, and the machine learning model 121 cannot provide that prospective response to the user. The machine learning model 121 may then proceed back to step 403 to generate another prospective response.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world-wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

FIG. 6 is a block diagram of a basic software system 600 that may be employed for controlling the operation of computing system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computing system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 600 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
training a machine learning model using training prompts querying a vector store to prevent unauthorized user disclosure of data derived from the hierarchical store;
receiving a prompt;
generating, using the machine learning model, a response to the prompt based at least in part on the vector store; and
wherein the method is performed by one or more computing devices.

2. The method of claim 1, wherein training the machine learning model comprises:
penalizing the machine learning model based on a first response to a first training prompt comprising sensitive information corresponding to an individual one of the plurality of vector stores; and
rewarding the machine learning model based on a second response to a second training prompt comprising aggregate information corresponding to multiple of the plurality of individual vector stores.

3. The method of claim 1, wherein the vector store stores one or more vector embeddings.

4. The method of claim 3, further comprising:
generating a query vector based at least in part on the prompt;
comparing the query vector with the one or more vector embeddings;
identify one or more vector similar vector embeddings from the vector store;
wherein the one or more similar vector embeddings having a similarity to the query vector that meets or exceeds a predetermined threshold of similarity; and
wherein the response is generated based at least in part on the one or more similar vector embeddings.

5. The method of claim 4, further comprising determining the similarity of the one or more similar vector embeddings to the query vector based at least in part on a cosine similarity of the one or more vector embeddings to the query vector.

6. The method of claim 4, further comprising:
decoding the one or more similar vector embeddings to obtain data related to the prompt; and
wherein the response is generated based at least in part on the data related to the prompt.

7. The method of claim 6, wherein the data related to the prompt comprises a context associated with the one or more similar vector embeddings.

8. The method of claim 7, wherein the machine learning model is a first machine learning model, the method further comprising determining, using a second machine learning model, whether the response comprises sensitive information corresponding to an individual one of the plurality of vector stores.

9. The method of claim 1, further comprising:
generating a plurality of individualized responses to the prompt, each of the plurality of individualized responses corresponding to one of the plurality of vector stores;
determining a similarity between the response and each of the plurality of individualized responses;
determining to mask the response based at least in part on the response having a similarity to fewer than a predetermined number of the plurality of individualized responses; and
regenerating, using the machine learning model, the response to the prompt based at least in part on the vector store.

10. The method of claim 1, wherein the machine learning model comprises a large language model.
training a machine learning model using training prompts querying a vector store to prevent unauthorized user disclosure of data derived from the vector store;
receiving a prompt;
generating, using the machine learning model, a response to the prompt based at least in part on the vector store; and
wherein the method is performed by one or more computing devices.

11. One or more non-transitory storage media storing instructions which, when executed by one or more computing devices, cause:
training a machine learning model using training prompts querying a vector store to prevent unauthorized user disclosure of data derived from the vector store;
receiving a prompt; and
generating, using the machine learning model, a response to the prompt based at least in part on the vector store.

12. The one or more non-transitory storage media of claim 11, wherein training the machine learning model comprises:
penalizing the machine learning model based on a first response to a first training prompt comprising sensitive information corresponding to an individual one of the plurality of vector stores; and
rewarding the machine learning model based on a second response to a second training prompt comprising aggregate information corresponding to multiple of the plurality of individual vector stores.

13. The one or more non-transitory storage media of claim 11, wherein the vector store stores one or more vector embeddings.

14. The one or more non-transitory storage media of claim 13, further comprising:
generating a query vector based at least in part on the prompt;
comparing the query vector with the one or more vector embeddings;
identify one or more vector similar vector embeddings from the vector store;
wherein the one or more similar vector embeddings having a similarity to the query vector that meets or exceeds a predetermined threshold of similarity; and
wherein the response is generated based at least in part on the one or more similar vector embeddings.

15. The one or more non-transitory storage media of claim 14, further comprising determining the similarity of the one or more similar vector embeddings to the query vector based at least in part on a cosine similarity of the one or more vector embeddings to the query vector.

16. The one or more non-transitory storage media of claim 14, further comprising:
decoding the one or more similar vector embeddings to obtain data related to the prompt; and
wherein the response is generated based at least in part on the data related to the prompt.

17. The one or more non-transitory storage media of claim 16, wherein the data related to the prompt comprises a context associated with the one or more similar vector embeddings.

18. The one or more non-transitory storage media of claim 11, wherein the machine learning model is a first machine learning model, the method further comprising determining, using a second machine learning model, whether the response comprises sensitive information corresponding to an individual one of the plurality of vector stores.

19. The one or more non-transitory storage media of claim 11, wherein performing data masking on the response comprises:
generating a plurality of individualized responses to the prompt, each of the plurality of individualized responses corresponding to one of the plurality of vector stores;
determining a similarity between the response and each of the plurality of individualized responses;
determining to mask the response based at least in part on the response having a similarity to a predetermined number of the plurality of individualized responses; and
regenerating, using the machine learning model, the response to the prompt based at least in part on the vector store.

20. The one or more non-transitory storage media of claim 11, wherein the machine learning model comprises a large language model.
